(19) United States
(12) Patent Application Publication
(10) Pub. No.: US 2024/0278164 A1
(43) Pub. Date: Aug. 22, 2024

(54) ROUND FILTER ELEMENT FOR FILTERING GASEOUS FLUID

(71) Applicant: MANN+HUMMEL GmbH, Ludwigsburg (DE)

(72) Inventors: Daniel SCHMID, Sachsenheim (DE); Philipp HETTKAMP, Steinheim (DE); Jürgen FREISINGER, Affalterbach (DE); Mario RIEGER, Ludwigsburg (DE)

(21) Appl. No.: 18/648,717

(22) Filed: Apr. 29, 2024

Related U.S. Application Data
(63) Continuation of application No. PCT/EP2022/077906, filed on Oct. 7, 2022.

(30) Foreign Application Priority Data
Nov. 4, 2021 (DE) 102021128689.1

(51) Int. Cl. B01D 46/64; B01D 46/00; B01D 46/52; B01D 53/04; H01M 8/0662

(52) U.S. Cl. CPC B01D 46/64; B01D 46/0036; B01D 46/521; B01D 53/0407; H01M 8/0687; B01D 2253/102; B01D 2257/302; B01D 2257/404; B01D 2257/406; B01D 2258/06; B01D 2271/027; B01D 2275/201

(57) ABSTRACT

A round filter element for gaseous fluid has a particle filter medium body formed as a hollow body for particle filtration and a separate harmful gas filter medium body formed as a hollow body for harmful gas filtration arranged concentrically to the particle filter medium body; together they surround an inner flow chamber. Particle filter medium body and harmful gas filter medium body each have opposed end faces with end disks. A flow-tight separate connection element is connected to an end disk of the particle filter medium body and engages a neighboring end disk of the harmful gas filter medium body or is connected to an end disk of the harmful gas filter medium body and engages a neighboring end disk of the particle filter medium body to produce a flow-tight connection with the neighboring end disk, respectively. A filter device is provided with such a round filter element.

### CROSS-REFERENCE TO RELATED APPLICATIONS

This application is a continuation application of international application No. PCT/EP2022/077906 having an international filing date of Oct. 7, 2022, and designating the United States, the international application claiming a priority date of Nov. 4, 2021, based on prior filed German patent application No. 10 2021 128 689.1, the entire contents of the aforesaid international application and the aforesaid German patent application being incorporated herein by reference.

### BACKGROUND OF THE INVENTION

The invention concerns a round filter element for filtering a gaseous fluid with a particle filter medium body configured as a hollow body for particle filtration and a separate harmful gas filter medium body configured as a hollow body for harmful gas filtration (e.g. sulfur dioxide, nitrogen oxides, ammonia) which is arranged concentrically to the particle filter medium body, wherein the two filter medium bodies surround an inwardly positioned flow chamber, wherein each filter medium body at its oppositely positioned end faces comprises a respective end disk.

DE 10 2018 215 603 A1 describes a modular filter element comprising a first raw air-side filter module and a second filter module positioned downstream which are each configured as a hollow cylinder and arranged concentrically relative to each other. The modular filter element can be used as a fuel cell air filter for air filtration of a fuel cell application. At the first raw air-side filter module a separation of particles takes place while the second filter module comprises an adsorption medium by means of which harmful gases are separated. Each filter module comprises at its oppositely positioned end faces a flow-tight end disk. The modular filter element with the two filter modules is received in a housing pot which can be closed by a housing cover.

### SUMMARY OF THE INVENTION

The invention has the object to design a round filter element for filtration of a gaseous fluid with two filter medium bodies, successively arranged in flow direction, in such a way that a high filtration performance is ensured over an extended operation duration.

This object is solved according to the invention for a round filter element for filtration of a gaseous fluid of the aforementioned kind in that a flow-tight separately embodied connection element is connected to one end disk of a filter medium body and engages an end disk of the neighboring filter medium body and produces a flow-tight connection to the end disk of the neighboring filter medium body.

The round filter element according to the invention serves for filtration of a gaseous fluid, for example, for filtration of air, and can be used, for example, in a fuel cell. The round filter element comprises a particle filter medium body by means of which particles are separated from the gaseous fluid and which is configured as a hollow body. The round filter element comprises furthermore a harmful gas filter medium body for harmful gas filtration which is configured also as a hollow body and arranged concentrically to the particle filter medium body. The two filter medium bodies surround a common inwardly positioned flow chamber. Each filter medium body is provided at both oppositely positioned end faces with a respective end disk which flow-tightly covers the respective filter medium body at the end face.

The flow through the round filter element is realized either radially from the interior to the exterior or, in reverse, radially from the exterior to the interior, wherein the term “radial” relates to the longitudinal axis of the round filter element. In case of a radial flow from the interior to the exterior, the non-purified raw fluid is first introduced into the inwardly positioned flow chamber from where the radial flow through the filter medium body from the interior to the exterior takes place. In case of radial flow from the exterior to the interior, the purified fluid is collected in the inwardly positioned flow chamber and axially discharged from it.

The filter medium bodies comprise, for example, a hollow cylinder shape or a conical shape. The filter medium bodies can have across their axial length-in relation to the longitudinal axis of the round filter element-either a constant cross-sectional surface area or a changing cross-sectional surface area, for example, a constantly increasing cross-sectional surface area. In a plane perpendicular to the longitudinal axis, the filter medium bodies can have a circular, oval or an elongate cross section shape, for example, a stadium shape with semi-circular narrow sides and flat longitudinal sides, wherein the longitudinal sides can also be convexly or concavely configured, as needed.

Each filter medium body comprises its own end disks, the end disks of the two filter medium bodies are not of a one-piece construction. In order to avoid air leakage flows between the filter medium bodies, a flow-tight separately configured connection element is connected to one of the end disks and engages an end disk of the neighboring filter medium body and produces a flow-tight connection to the end disk of the neighboring filter medium body in this manner. In addition, the relative position of the two filter medium bodies to each other is fixed by means of the connection element.

The connection element does not constitute a housing component but is a component of the round filter element and forms a structural unit together with the two filter medium bodies. The round filter element including the connection element can be inserted into a filter housing, wherein filter housing and round filter element form a filter device.

The connection element is embodied, for example, as a plastic component. Since the connection element bridges the distance between the filter medium bodies in the region of the end disks, the annular space which is located between the filter medium bodies is closed off fluid-tightly so that air leakage flows between raw side and clean side are prevented.

The connection element may be configured of an annular shape. The connection element is configured separate from the end disks of the filter medium bodies but is connected fixedly to one end disk. This is realized, for example, in that the end disk is formed as a cast part of, for example, a soft-elastic material which is cast onto the end face of the filter medium body, wherein at the same time a section of the connection element projects into the end disk material and, upon curing, a fixed connection between end disk and connection element is produced. As end disk material, for example, polyurethane or plastic material is conceivable.

According to an advantageous embodiment, a section of the connection element projects into the intermediate space between the two filter medium bodies and rests laterally against the end disk of the neighboring filter medium body. This section of the connection element ensures, on the one hand, a constant relative radial spacing between the two filter medium bodies. On the other hand, this section enables a seal-tight connection to the end disk of the neighboring filter medium body in that, for example, this end disk contacts immediately the section of the connection element. This ensures that no air leakage flow can escape in axial direction from the intermediate space between the two filter medium bodies but that instead the fluid is forced to flow through the second filter medium body in radial direction.

According to a further advantageous embodiment, a section of the connection element rests laterally against the end disk of the neighboring filter medium body at the side which is facing away from the holding filter medium body. At this section of the connection element there exists also an additional seal location in that the end disk of the neighboring filter medium body contacts the connection element section. A further contact can exist axially between the end disk of the neighboring filter medium body and the engaging part of the connection element. In this manner, up to three seal locations as a whole can be provided between the connection element and the end disk of the neighboring filter medium body which is not carrying the connection element: On the one hand, by the section of the connection element projecting between the two filter medium bodies and the end disk, which provides a seal in radial direction; on the other hand, between the outwardly positioned section of the connection element and the end disk, which constitutes also a radial seal; and finally axially between the end disk and the engaging part of the connection element, which constitutes an axial seal. In this way, a tolerance compensation and a reliable sealing action are enabled.

It is furthermore advantageous that the two lateral sections of the connection element form a receiving space for the end disk of the non-holding filter medium body so that this filter medium body including its end disk can be pushed into the receptacle at the connection element, whereby a seal-tight connection is produced at the same time. In this way, a simple assembly of the round filter element is possible.

According to yet another advantageous embodiment, a further section of the connection element is a carrier of a seal element which can be supported at a housing part. The seal element can be inserted into a receiving groove which is formed at the section of the connection element, wherein the part of the seal element projecting from the receiving groove is supported at the housing part and, in this manner, provides a flow-tight connection between the connection element and the housing part. This configuration has the advantage that, for example, a flow-tight closure can be produced between a housing pot and the connection element so that the fluid at the clean side is forced to take the outflow channel in the filter housing which is provided for the discharge. For example, the receiving groove is open axially downwardly or upwardly so that the inserted seal element seals in axial direction. The seal can be arranged between the housing pot and a housing cover to be placed thereon so that the contact pressure for the seal is applied by the closure elements for connection of the two housing parts. The connection between the housing pot and the housing cover to be placed thereon must not mandatorily be embodied flow-tight in this embodiment.

According to an advantageous embodiment, at least at one filter medium body a support frame, for example, a support grid, is arranged. The support frame comprises a plurality of flow openings for the medium to be purified and stabilizes at the same time the filter medium body. The support frame may be, for example, arranged at the outflow side of the harmful gas filter medium body and/or of the particle filter medium body.

According to a further advantageous embodiment, the connection element is connected to a support grid which is arranged at a wall side of a filter medium body. The support grid may be located at the outwardly positioned wall side of the radially inwardly positioned filter medium body, wherein this wall side may form the outflow side of the filter medium body at the same time. The support grid supports the immediately contacting filter medium body in radial direction. The support grid may be, for example, fixedly connected to the axially oppositely positioned end disks of the filter medium body in that a section of the support grid projects into the material of the respective end disk. The support grid can be embodied as one piece together with the connection element, wherein the support grid extends at a wall side of the filter medium body and the connection element radially outwardly substantially along the axial end face of the neighboring radially outer filter medium body.

According to yet another advantageous embodiment, one filter medium body or both filter medium bodies are configured as filter bellows with a plurality of filter folds. Alternatively, it is also possible to manufacture one or both filter medium bodies of a block-shaped material or of a wound filter medium.

According to yet another advantageous embodiment, a medium layer, in particular a nonwoven layer, is arranged at the wall side of a filter medium body. The medium layer reduces the friction between the filter medium body and an adjoining component, in particular a support grid, that supports the respective filter medium body. Due to the reduced friction, a deformation of the filter medium body in case of relative movements, for example, caused by vibrations or blows, can be avoided.

The nonwoven layer is located either between the two filter medium bodies and/or at an outer side of a filter medium body, wherein advantageously in any case the nonwoven layer is arranged between a support grid and the wall side of the filter medium body. Advantageously, a nonwoven layer is arranged at the outflow side of the harmful gas filter medium body so that particles that have been carried away, for example, active carbon particles from the filter medium, are retained.

According to an embodiment which is advantageous in particular in regard to filter elements of great length, at least one of the filter medium bodies is comprised of at least two partial bodies which are joined to each other in axial direction. The partial bodies can be glued to each other, for example.

The invention concerns furthermore a filter device with an afore described round filter element and a filter housing for receiving the round filter element. The filter device can be used in or at a fuel cell, for example, in the supply region of the ambient air that is to be supplied to a fuel cell, in order to subject the ambient air to a filtration.

### BRIEF DESCRIPTION OF THE DRAWINGS

Further advantages and expedient embodiments can be taken from the additional claims, the figure description, and the drawings.

FIG. 1a shows a schematic section through a filter device with a round filter element in a filter housing.

FIG. 1b shows the detail Ib of FIG. 1a in enlarged illustration.

FIG. 1c shows the detail Ic of FIG. 1a in enlarged illustration.

FIG. 1d shows a perspective illustration of the round filter element, partially in section.

FIG. 2a shows an illustration corresponding to FIG. 1a of a filter device with a round filter element in a further embodiment.

FIG. 2b shows the detail IIb of FIG. 2a in enlarged illustration.

FIG. 2c shows the detail IIc of FIG. 2a in enlarged illustration.

FIG. 3a shows an illustration corresponding to FIG. 1a of a filter device with a round filter element in yet another embodiment.

FIG. 3b shows the detail IIIb of FIG. 3a in enlarged illustration.

FIG. 3c shows the detail IIIc of FIG. 3a in enlarged illustration.

In the Figures, same components are identified with same reference characters.

### DETAILED DESCRIPTION

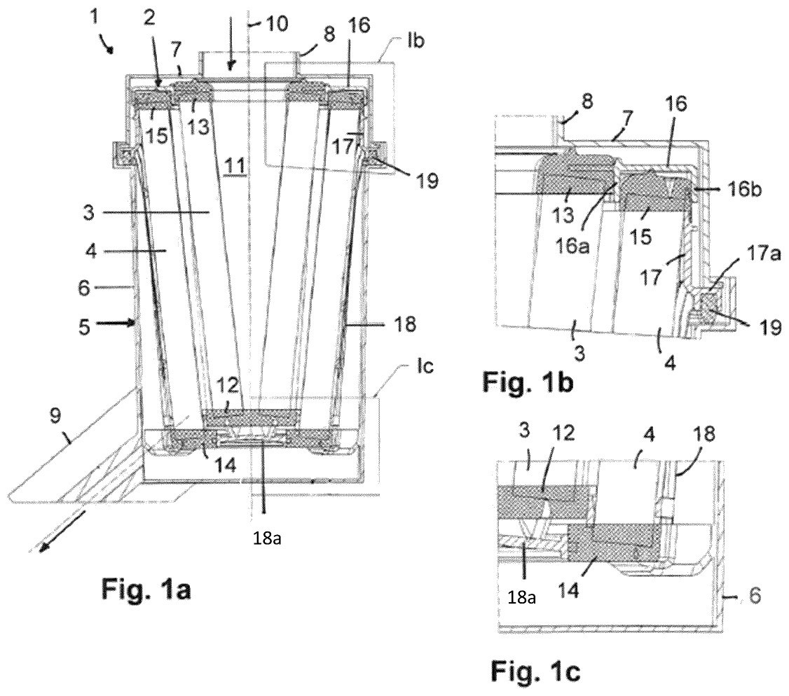

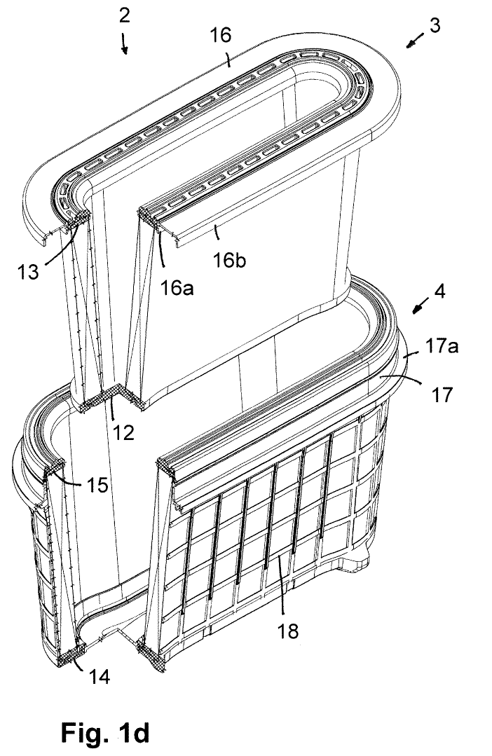

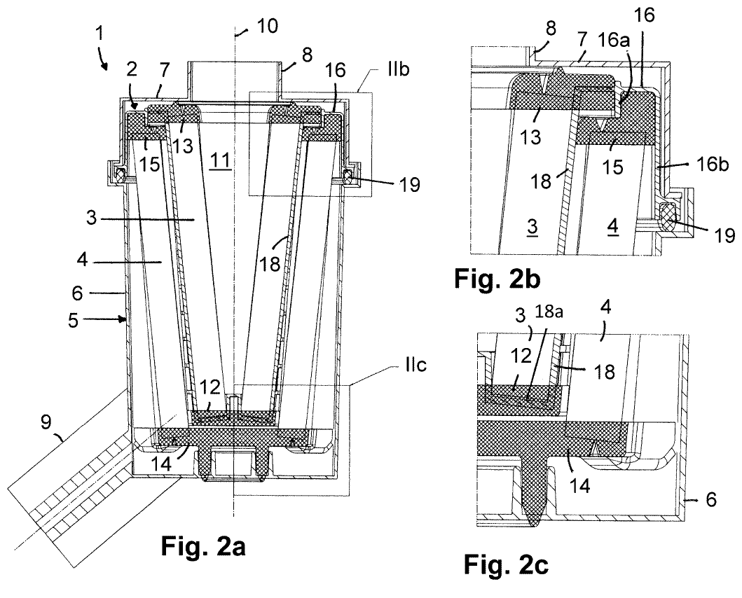

In FIGS. 1a to 1d, a filter device 1 with a first round filter element 2 for filtration of a gaseous fluid is illustrated. The filter device 1 comprises a longitudinal axis 10, wherein FIG. 1a—and also FIG. 2a—shows only the left section half on one side of the longitudinal axis 10. The filter device 1 is used, for example, for filtration of the fresh air supplied to a fuel cell.

The round filter element 2 comprises two filter medium bodies 3, 4 which are embodied as particle filter medium body 3 for filtration of particles and as harmful gas filter medium body 4 for filtration of harmful gases such as, for example, sulfur dioxide, nitrogen oxides or ammonia. The two filter medium bodies 3, 4 may be embodied as filter bellows of zigzag-shaped folded filter medium. The harmful gas filter medium body 4 can contain active carbon in order to adsorb the harmful gases in the desired manner. Active carbon particles may be embedded in the filter medium of the harmful gas filter medium body 4. The filter medium bodies 3 and 4 are, for example, conically embodied and have an elongate flat-oval cross section shape with two parallel longitudinal sides and two convex narrow sides. The two filter medium bodies 3 and 4 are arranged concentrically to each other and surround an inwardly positioned flow chamber 11 which receives the non-purified raw fluid and from where the two filter medium bodies 3 and 4 are flowed through radially from the interior to the exterior, in relation to the longitudinal axis 10.

The round filter element 2 is received in a filter housing 5 which comprises a housing pot 6 and a housing cover 7. At the housing cover 7, an inlet 8 is integrally formed through which the non-purified raw fluid is introduced and supplied to the inwardly positioned flow chamber 11. At the housing pot 7, an outlet 9 is integrally formed through which the purified fluid is discharged which, after flowing through the two filter medium bodies 3 and 4, collects at the outer side of the surrounding harmful gas filter medium body 4 rearwardly positioned in flow direction. The inwardly positioned side of the particle filter medium body 3 forms the raw side or inflow side, the outer side of the harmful gas filter medium body 4 the clean side or outflow side.

Each filter medium body 3, 4 is provided at both axially oppositely positioned end faces with an end disk 12, 13 or 14, 15 which flow-tightly covers the respective axial end face. The end disks 12 to 15 can be cast onto the filter medium bodies. The lower end disk 12 of the particle filter medium body 3 which is facing the bottom of the housing pot 6 is configured as a continuous disk and has no cutout. On the other hand, the upper end disk 13 of the same particle filter medium body 3 is annular with a central cutout through which the raw air can flow via the air inlet 8 into the inwardly positioned flow chamber 11.

The upper end disk 15 of the harmful gas filter medium body 4 is also of an annular configuration. The lower end disk 14 of the harmful gas filter medium body 4 is of a closed configuration, wherein the lower end disk 14 has two parts with a foamed-on soft plastic material covering the end face of the filter medium body 4 and with a plastic disk which covers the opening to the interior and which is embedded into the foamed-on plastic material. As will be explained in detail below, the plastic disk can be a section 18a of a support grid 18. As an alternative, the lower end disk 14 can be embodied as one piece of a foamed plastic material.

At the upper end disk 13 of the particle filter medium body 3 which is facing the housing cover 7, a first flow-tightly embodied connection element 16 is located which projects radially outwardly and is configured in an annular circumferentially extending shape. A section of the connection element 16 is received in the material of the upper end disk and fixedly connected to the end disk 13 in this manner. The connection element 16 engages the upper end disk 15 of the neighboring radially farther outwardly positioned harmful gas filter medium body 4, wherein a flow-tight connection between the end disk 15 and the connection element 16 is produced. From the part which is extending in radial direction, a first section 16a of the connection element 16 projects axially inwardly into the intermediate space between the two filter medium bodies 3, 4. A second section 16b projects axially downwardly at the radially outwardly positioned side of the upper end disk 15 so that the two sections 16a and 16b form an annular receptacle for the upper end disk 15 of the harmful gas filter medium body 4 into which the upper end disk 15 can be inserted. In this context, seal locations are formed with the connection element 16 or the sections 16a and 16b at the radially inwardly positioned side and at the radially outwardly positioned side of the end disk 15. As an alternative or in addition, a seal location is formed between the axial end face of the end disk 15 and the connection element 16. In principle, the provision of one of the three seal locations is sufficient. The connection element 16 is flow-tightly embodied so that a flow-tight connection to the upper end disk 15 is ensured and air leakage flows of the fluid, which is located in the intermediate space between the filter medium bodies 3, 4, are prevented in axial outward direction.

At an outwardly positioned wall side or jacket side of the harmful gas filter medium body 4, a support grid 18 is arranged. This support grid 18 surrounds the harmful gas filter medium body 4 at the outer side and is embedded, and thus held, at the end face in the material of the end disks 14, 15. A seal carrier 17 is connected as one piece with the support grid 18. The carrier is configured as a circumferentially extending radially outwardly projecting collar which comprises an axially downwardly open receiving groove 17a for a seal element 19. The seal element 19 in the form of a seal ring can be inserted into the receiving groove 17a. As an alternative, the seal element can be molded on. The seal element 19 is positioned on a shoulder of the housing pot 6 and seals the raw side against the clean side.

A media layer, for example, a nonwoven layer, can be located between the support grid 18, which comprises a plurality of flow openings, and the outwardly positioned jacket side of the harmful gas filter medium body 4. It forms a mechanical guard against friction and retains in particular active carbon particles which may escape from the harmful gas filter medium body 4.

A section of the support grid 18 is continued in the lower end disk 14 radially inwardly as a section 18a, wherein the section 18a is formed radially within the filter medium as a closed flow-tight disk. The lower end disk 12 of the particle filter medium body 3 is axially supported at the section 18a. As can be seen in FIG. 1c, the section 18a can comprise an annular section which in axial direction extends into the interior of the harmful gas filter medium body 4. The inner particle filter medium body 3 with the lower end disk 12 is radially supported at this rib.

When the inner particle filter medium body 3 is inserted into the outer harmful gas filter medium body 4, the two filter medium bodies 3, 4 are thus seal-tightly connected to each other by the at least one seal location between the upper end disk 15 of the outer filter medium body 4 and the connection element 16.

Between the round filter element 2 and filter housing 5, there is also a seal location formed. In the region of the raw fluid inlet 8, the upper end disk 13 of the inner filter medium body 3 is supported, for example, axially at the housing cover 7 without sealing action. The seal location between raw side and clean side is located radially outwardly and is embodied as axial seal by the seal element 19 supported at the outer filter medium body 4 contacting a collar of the housing pot 6.

FIG. 1d shows a perspective illustration of the round filter element 2 with the outer harmful gas filter medium body 4 and the inner particle filter medium body 3 received therein. The connection element 16 connected to the upper end disk 13 of the inner particle filter medium body 3 forms a radially outwardly projecting wall section with an inner axially downwardly extending section 16a and an outer also axially downwardly extending section 16b so that a U-shaped receptacle for engagement of the upper end disk 15 of the outer harmful gas filter medium body 4 is formed.

The support grid 18 with the seal carrier 17, which comprises the receiving groove 17a for the seal element 19, is connected to the upper end disk 15 of the outer harmful gas filter medium body 4.

Harmful gas filter medium body 4 and particle filter medium body 3 are thus joinable in a simple manner to a unit and insertable into the housing. On the other hand, the two filter medium bodies 3, 4 can be separated again easily. In this way, it is possible, for example, in case of different service lives, to replace only one of the two filter medium bodies 3, 4 with a new one and to continue to use the other one. In comparison to a one-part embodiment, no additional seal is required because the end disk 15 of the outer filter medium body 4 is used for sealing.

In FIGS. 2a to 2c, a further embodiment is illustrated which in principle has the same configuration as the first embodiment so that in this respect reference is being had to the description above. In FIGS. 2a to 2c, the filter device also comprises a round filter element 2 comprising a particle filter medium body 3 and a surrounding harmful gas filter medium body 4 which surround an inwardly positioned flow chamber 11. The filter medium bodies 3, 4 are flowed through radially from the interior to the exterior by the fluid to be purified.

In contrast to FIGS. 1a to 1d, in FIGS. 2a to 2c no support grid is arranged on the outwardly positioned wall side or jacket side of the harmful gas filter medium body 4. A support grid 18 is located however in the intermediate space between the filter medium bodies 3 and 4 and is correlated with the particle filter medium body 3. A nonwoven layer can be located between the support grid 18 and the neighboring side face of the particle filter medium body 3.

The support grid 18 can be embodied as one piece together with the connection element 16 which is connected fixedly to the upper end disk 13 of the particle filter medium body 3, for example, is embedded therein. The section 16a of the connection element 16 projects between the filter medium bodies 3 and 4 axially in direction of the intermediate space and forms a radial seal location with the upper end disk 15 of the harmful gas filter medium body 4. A second section 16b projects radially outwardly positioned in axial direction downwardly and forms a further radial seal location with the upper end disk 15. In addition or as an alternative, the axial end face of the upper end disk 15 forms a seal location with the radially extending part of the connection element 16.

The upper end disk 15 of the harmful gas filter medium body 4 comprises at the radially inwardly positioned side an upper shoulder; the section 16a of the connection element 16 is resting at its vertical side. The upper end disk 13 of the inwardly positioned particle filter medium body 3 projects into the shoulder in the upper end disk 15. The upper end disk 15 of the harmful filter medium body 4 rests in radial direction at the support grid 18 of the particle filter medium body 3. The support grid 18 in this region can be of a closed configuration and in this way form a contact rib for the upper end disk 15 of the harmful gas filter medium body 4 so that an additional seal location can be formed.

The radially outwardly positioned section 16b of the connection element 16 comprises in addition a receiving groove in which a seal element 19 is inserted which is supported at a shoulder of the housing pot 6. The connection element 16 forms thus at the same time the seal carrier for the seal element 19.

The lower end disk 14 is configured as a continuous disk. At the lower end disk 14 an axially downwardly oriented hollow-cylindrical sleeve is formed which is received with form fit in an annular receptacle at the bottom of the housing so that the round filter element 2 is stably held. The lower end disk 14 may be produced of a flexible material, for example, polyurethane foam.

The connection element 16 and the support grid 18 form a common continuous component which finds a one-piece continuation in the section 18a in the region of the lower end disk 12 of the particle filter medium body 3. This section 18a of the support grid 18 is of a disk-shaped configuration and is at least partially enclosed by the material of the lower end disk 12 so that a fixed connection to the lower end disk 12 exists. The disk-shaped section 18a is at least in sections configured so as to be flow-tight and prevents an air leakage flow of the raw fluid, bypassing the particle filter medium body 3, from the inwardly positioned flow chamber 11 to the harmful gas filter medium body 4.

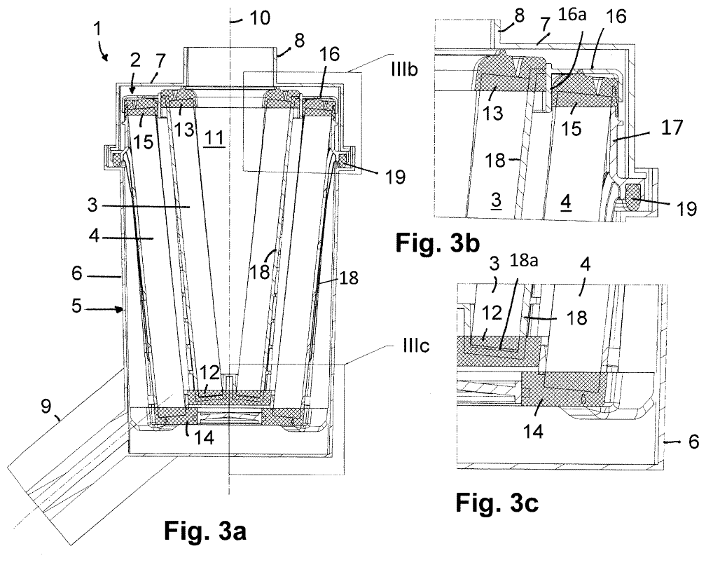

The embodiment illustrated in FIGS. 3a to 3c corresponds substantially to the embodiment according to FIGS. 2a to 2c. In FIGS. 3a to 3c, the upper end disk 15 of the outer harmful gas filter medium body 4 comprises however—in relation to the illustrated section plane which contains the longitudinal axis—a substantially rectangular cross section shape, like the upper end disk 13 of the particle filter medium body 3 which is displaced radially inwardly in relation to the end disk 15. The upper end disk 15 of the outer harmful gas filter medium body 4 thus comprises no shoulder. The section 16a of the connection element 16 is located between the end disks 13 and 15 and rests at the radially outer side of the end disk 13 as well as at the radially inner side of the end disk 15. Furthermore, in this embodiment the inner particle filter medium body 3 as well as the outer harmful gas filter medium body 4 comprises a support grid 18. The radially outwardly positioned support grid 18 of the harmful gas filter medium body 4 comprises the seal carrier 17. As an alternative, the seal carrier 17 can also be formed by a radially outwardly positioned section 16b of the connection element 16 which is extended in axial direction.

The lower end disk 14 of the outer harmful gas filter medium body 4, as in the first embodiment, is substantially of a planar configuration. However, the lower end disk 14 could also be embodied in accordance with the lower end disk 14 of FIG. 2a.

What is claimed is:

1. A round filter element for filtration of a gaseous fluid, the round filter element comprising:
a particle filter medium body configured as a hollow body for particle filtration of the gaseous fluid;
a harmful gas filter medium body configured as a hollow body for harmful gas filtration, wherein the harmful gas filter medium body is separate from the particle filter medium body and is arranged concentrically to the particle filter medium body;
wherein the particle filter medium body and the harmful gas filter medium body surround an inwardly positioned flow chamber;
wherein the particle filter medium body comprises oppositely positioned end faces with an end disk, respectively;
wherein the harmful gas filter medium body comprises oppositely positioned end faces with an end disk, respectively;
a flow-tight separate connection element, wherein the flow-tight separate connection element is connected to one of the end disks of the particle filter medium body and engages a neighboring one of the end disks of the harmful gas filter medium body to produce a flow-tight connection with the neighboring end disk, or the flow-tight separate connection element is connected to one of the end disks of the harmful gas filter medium body and engages a neighboring one of the end disks of the particle filter medium body to produce a flow-tight connection with the neighboring end disk.

2. The round filter element according to claim 1, wherein the flow-tight separate connection element comprises a section projecting into an intermediate space disposed between the particle filter medium body and the harmful gas filter medium body and contacts laterally the neighboring end disk of the harmful gas filter medium body or the neighboring end disk of the particle filter medium body engaged by the flow-tight separate connection element, respectively.

3. The round filter element according to claim 1, wherein the flow-tight separate connection element comprises a section contacting the neighboring end disk of the harmful gas filter medium body or the neighboring end disk of the particle filter medium body engaged by the flow-tight separate connection element, respectively, at a side facing away from the harmful gas filter medium body or from the particle filter medium body to which the flow-tight separate connection element is connected, respectively.

4. The round filter element according to claim 3, wherein the section of the flow-tight separate connection element is a carrier of a seal element for support at a housing part.

5. The round filter element according to claim 1, further comprising a support grid arranged at a wall side of the harmful gas filter medium body or arranged at a wall side of the particle filter medium body, wherein the flow-tight separate connection element is connected to the support grid.

6. The round filter element according to claim 1, wherein the harmful gas filter medium body or the particle filter medium body is a filter bellows.

7. The round filter element according to claim 1, wherein the harmful gas filter medium body is a filter bellows and the particle filter medium body is a filter bellows.

8. The round filter element according to claim 1, further comprising a media layer arranged at a wall side of the particle filter medium body or arranged at a wall side of the harmful gas filter medium body.

9. The round filter element according to claim 8, wherein the media layer is a nonwoven layer.

10. The round filter element according to claim 8, wherein the media layer is arranged between the particle filter medium body and the harmful gas filter medium body.

11. The round filter element according to claim 8, wherein the media layer is arranged at an outer side of the particle filter medium body or arranged at an outer side of the harmful gas filter medium body.

12. The round filter element according to claim 1, wherein the particle filter medium body or the harmful gas filter medium body is comprised of at least two partial bodies joined to each other in axial direction.

13. The round filter element according to claim 1, wherein the particle filter medium body and the harmful gas filter medium body each are comprised of at least two partial bodies joined to each other in axial direction.

14. A filter device comprising:
a round filter element according to claim 1; and
a filter housing configured to receive the round filter element.

15. The filter device according to claim 14, configured for use in or at a fuel cell.
